(19) United States
(12) Patent Application Publication
(10) Pub. No.: US 2026/0321562 A1
(43) Pub. Date: Oct. 15, 2026

(54) MASS SPECTROMETRY METHOD AND MASS SPECTROMETRY APPARATUS

(71) Applicant: SHIMADZU CORPORATION, Kyoto-shi, Kyoto (JP)

(72) Inventors: Hideki YAMAMOTO, Kyoto-shi (JP); Kosuke UCHIYAMA, Kyoto-shi (JP)

(73) Assignee: SHIMADZU CORPORATION, Kyoto-shi, Kyoto (JP)

(21) Appl. No.: 19/482,389

(22) PCT Filed: May 18, 2023
(86) PCT No.: PCT/JP2023/018634

§ 371 Date: Nov. 7, 2025

(51) Int. Cl. H01J 49/00

(52) U.S. Cl. CPC H01J 49/0036

(57) ABSTRACT

A mass spectrometry method using a mass spectrometry apparatus capable of performing MS/MS analysis by DDA, includes a detection step of detecting, based on mass spectra obtained by repeatedly executed survey scan measurements, an m/z value of a peak that is continuously observed over a predetermined period; a registration step of registering the detected m/z value or an m/z range including the m/z value in an exclusion ion list; a precursor selection step of, after a mass spectrum is obtained by a survey scan measurement, excluding at least the m/z value or m/z range registered in the exclusion ion list from a precursor selection target in the mass spectrum, and extracting an ion that conforms to a predetermined precursor selection condition; and a measurement step of executing an MS/MS analysis with the extracted ion as a precursor ion, subsequent to the survey scan measurement in the precursor selection step.

### TECHNICAL FIELD

The present invention relates to a mass spectrometry method and a mass spectrometry apparatus, and more particularly, to a mass spectrometry method utilizing MS/MS analysis and a mass spectrometry apparatus capable of MS/MS analysis.

### BACKGROUND ART

In recent years, tandem mass spectrometry apparatuses capable of MS/MS analysis, such as triple quadrupole mass spectrometers and quadrupole-time-of-flight mass spectrometers, have been widely used for the identification, quantification, or structural analysis of compounds in complex samples containing a wide variety of compounds. In liquid chromatograph-mass spectrometers (LC-MS) and gas chromatograph-mass spectrometers (GC-MS) that use a tandem mass spectrometer as a detector, Data Dependent Acquisition (DDA, or Data Dependent Analysis) is well known as one of the MS/MS analysis techniques in the mass spectrometer (see Patent Literatures 1 and 2).

In DDA, first, a mass spectrum is acquired by a normal scan measurement that does not dissociate ions (hereinafter sometimes referred to as a “survey scan”), and based on the signal intensity, etc., of peaks observed in that mass spectrum, a peak of a specific mass-to-charge ratio (strictly speaking, denoted in italics as m/z, but referred to as “m/z” or “mass-to-charge ratio” in this description) is selected. Then, following the survey scan, an MS/MS analysis (product ion scan measurement) is performed with the ion having the m/z value corresponding to the selected peak as a precursor ion, to acquire an MS/MS spectrum in which various product ions are observed.

DDA is also called the shotgun method, and it is desirable to collect information on product ions corresponding to various types of compounds contained in a sample as comprehensively as possible. However, in LC-MS and GC-MS, since compounds of the same type are continuously introduced into the mass spectrometer for a certain period, if a process that simply selects a peak with a large signal intensity in the mass spectrum is implemented, there is a concern that product ion information derived from the same compound will be continuously collected. To avoid this, conventional apparatuses employ a function (hereinafter referred to as “previously selected ion automatic exclusion function”) that excludes the m/z value of a peak once selected as a precursor ion from the precursor ion selection target for a predetermined validity period. This validity period is typically determined according to the time during which a single component continues to elute from the LC (or GC) column, for example, as 10 seconds.

Furthermore, Patent Literature 3 describes a function (hereinafter referred to as “exclusion ion prior registration function”) that excludes ions from being selected as precursor ions by registering in advance ions such as known contaminant components, interfering components, and components known to not require analysis in an exclusion ion list.

### PRIOR ART DOCUMENTS

### Patent Literature

[Patent Literature 1] International Publication No. WO 2017/158770

[Patent Literature 2] Japanese Unexamined Patent Application Publication No. 2012-2544

[Patent Literature 3] Japanese Unexamined Patent Application Publication No. 2012-225862

### SUMMARY OF INVENTION

### Problem to be Solved by the Invention

The above-mentioned exclusion ion prior registration function can only exclude from the precursor selection target ions that have a specific m/z value or are included in a specific m/z range, as set by the user in advance. Therefore, for example, in cases where contaminants that the user does not intend or cannot anticipate are mixed in the mobile phase of the LC, it is not possible to remove ions derived from such contaminants from the precursor selection target. As a result, there is a concern that MS/MS analysis corresponding to such undesired ions will be repeated, reducing the opportunities to acquire product ion information derived from components that the user wishes to check.

Of course, although it is possible to exclude ions derived from unintended contaminants from the precursor selection target by the previously selected ion automatic exclusion function described above, its validity period is usually short, so once that validity period ends, MS/MS analysis with ions derived from unintended contaminants as precursor ions will be executed again. This hinders the comprehensive collection of product ion information derived from components that the user originally wishes to check.

The present invention has been made to solve these problems, and its main object is to provide a mass spectrometry method and a mass spectrometry apparatus that can avoid the execution of MS/MS analysis on ions derived from undesired components that are not known to be detected in advance, and can efficiently and comprehensively collect information on product ions derived from target components.

### Means for Solving the Problem

One aspect of the mass spectrometry method according to the present invention is a mass spectrometry method using a mass spectrometry apparatus capable of performing MS/MS analysis by Data Dependent Acquisition (DDA), comprising:
a detection step of detecting, based on mass spectra obtained by repeatedly executed survey scan measurements, a peak having an m/z value that is continuously observed over
a predetermined period;
a registration step of registering the m/z value of the peak detected in the detection step or an m/z range including the m/z value in an exclusion ion list;
a precursor selection step of, after a mass spectrum is obtained by a survey scan measurement, excluding at least the m/z value or m/z range registered in the exclusion ion list from a precursor selection target in the mass spectrum, and extracting an ion that conforms to a predetermined precursor selection condition; and
a measurement step of executing an MS/MS analysis with the ion extracted in the precursor selection step as a precursor ion, subsequent to the survey scan measurement in the precursor selection step.

Further, one aspect of the mass spectrometry apparatus according to the present invention is a mass spectrometry apparatus capable of performing MS/MS analysis by Data Dependent Acquisition (DDA), comprising:
a specific peak detection unit that detects, based on mass spectra obtained by repeatedly executed survey scan measurements, a peak having an m/z value that is continuously observed over a predetermined period;
an exclusion ion registration unit that registers the m/z value of the peak detected by the specific peak detection unit or an m/z range including the m/z value in an exclusion ion list;
a measurement unit that executes a survey scan measurement and, subsequent to the survey scan measurement, executes an MS/MS analysis with an ion extracted by a precursor selection unit described later, based on the mass spectrum obtained by the measurement, as a precursor ion; and
a precursor selection unit that, in the mass spectrum obtained by the survey scan measurement executed in the measurement unit, excludes at least the m/z value or m/z range registered in the exclusion ion list from a precursor selection target, and extracts an ion that conforms to a predetermined precursor selection condition.

Here, the “peak having an m/z value that is continuously observed over a predetermined period” detected in the detection step and the specific peak detection unit may be any peak that can be regarded as having substantially the same m/z value. Therefore, for example, in cases where the apparent m/z value of a peak with the same true m/z value varies or fluctuates due to constraints of the apparatus's performance or variations in the measurement environment or measurement conditions, such varied or fluctuated m/z values shall also be regarded as identical.

Furthermore, the survey scan measurement from which the mass spectrum used in the detection step and the specific peak detection unit is obtained, and the survey scan measurement from which the mass spectrum used for ion extraction in the precursor selection step and the precursor selection unit is obtained, may be the same measurement, or they may be measurements performed at different timings.

### Advantageous Effects of Invention

According to the above aspect of the mass spectrometry method and mass spectrometry apparatus of the present invention, it is possible to avoid the repeated selection of ions derived from components that may be observed throughout the entire measurement time, such as contaminants mixed in the mobile phase used in LC in an LC-MS, as precursor ions and the execution of MS/MS analysis. This makes it possible to more efficiently and comprehensively collect product ion information corresponding to the components originally targeted by the user contained in the sample.

### BRIEF DESCRIPTION OF DRAWINGS

FIG. 1 A schematic configuration diagram of an LC-MS according to an embodiment of the present invention.

FIG. 2 A flowchart showing an example of the execution procedure for analysis in DDA mode in the LC-MS of this embodiment.

FIG. 3 A schematic diagram showing the correspondence between measurement time and processing in the LC-MS of this embodiment.

### DESCRIPTION OF EMBODIMENTS

Since the mass spectrometry apparatus according to the present invention need only be capable of MS/MS analysis, it can include, for example, a triple quadrupole mass spectrometer, a quadrupole-time-of-flight mass spectrometer (hereinafter referred to as “Q-TOFMS”), an ion trap-time-of-flight mass spectrometer, an ion trap mass spectrometer, and the like. Typically, the mass spectrometry apparatus according to the present invention can be configured as an LC-MS or GC-MS in combination with an LC or GC.

Hereinafter, an embodiment of an LC-MS using the mass spectrometry apparatus according to the present invention will be described with reference to the accompanying drawings.

### Configuration of the LC-MS

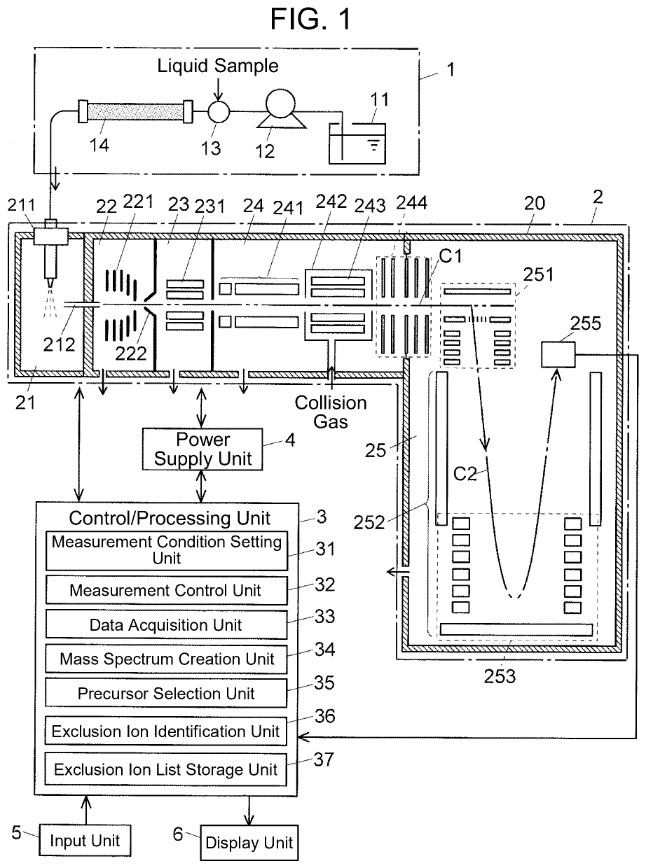

FIG. 1 is a schematic configuration diagram of the LC-MS of this embodiment.

This LC-MS comprises a liquid chromatograph (LC) unit 1 and a mass spectrometry (MS) unit 2 as a measurement unit, and further comprises a control/processing unit 3, a power supply unit 4, an input unit 5, and a display unit 6.

The LC unit 1 includes a mobile phase container 11, a liquid delivery pump 12, an injector 13, and a column 14.

The MS unit 2 is a Q-TOFMS and includes an ionization chamber 21 which is in a substantially atmospheric pressure atmosphere, and a vacuum chamber 20 which is internally divided into four sections. Inside the vacuum chamber 20, a first intermediate vacuum chamber 22, a second intermediate vacuum chamber 23, a first high vacuum chamber 24, and a second high vacuum chamber 25 are provided, and each chamber is vacuum-exhausted by a vacuum pump (not shown) such that the degree of vacuum increases in this order.

In the ionization chamber 21, an electrospray ionization (ESI) probe 211 to which a liquid sample (eluate) is supplied from the LC unit 1 is arranged, and the ionization chamber 21 and the first intermediate vacuum chamber 22 communicate through a thin desolvation tube 212. The first intermediate vacuum chamber 22 and the second intermediate vacuum chamber 23 communicate through an orifice formed at the apex of a skimmer 222, and ion guides 221 and 231 are arranged in the first intermediate vacuum chamber 22 and the second intermediate vacuum chamber 23, respectively. In the first high vacuum chamber 24, a quadrupole mass filter 241 and a collision cell 242, in which an ion guide 243 is arranged, are provided along an ion optical axis C1. A plurality of electrodes arranged across the first high vacuum chamber 24 and the second high vacuum chamber 25 constitute an ion guide 244. In the second high vacuum chamber 25, an orthogonal acceleration time-of-flight mass separator comprising an orthogonal acceleration unit 251 and an ion flight unit 252 including a reflectron 253, and an ion detector 255 are provided.

The power supply unit 4 drives the MS unit 2 by applying predetermined voltages to electrodes and the like included in the MS unit 2, under the control of the control/processing unit 3. The control/processing unit 3 is responsible for controlling the operation of the LC unit 1 and the MS unit 2 and processing the data obtained by the MS unit 2, and includes, as functional blocks, a measurement condition setting unit 31, a measurement control unit 32, a data acquisition unit 33, a mass spectrum creation unit 34, a precursor selection unit 35, an exclusion ion identification unit 36, and an exclusion ion list storage unit 37.

In general, the control/processing unit 3 is embodied by a computer such as a personal computer or a workstation, and the above-mentioned functional blocks are realized by executing one or more dedicated software programs (computer programs) installed on such a computer. Such a computer program can be provided to the user stored in a computer-readable non-transitory recording medium such as a CD-ROM, a DVD-ROM, a memory card, a USB memory (dongle), or the like. Alternatively, it can be provided to the user in the form of data transfer via a communication line such as the Internet. Alternatively, it can be pre-installed on a computer that is part of the system at the time the user purchases the system.

### Schematic Measurement Operation of the LC-MS

In the LC unit 1, under the control of the measurement control unit 32, the liquid delivery pump 12 draws the mobile phase from the mobile phase container 11 and delivers the mobile phase to the column 14 at a predetermined flow velocity (flow rate). The injector 13 injects the liquid sample into the mobile phase at a predetermined timing according to an instruction from the measurement control unit 32. The liquid sample is carried by the flow of the mobile phase and sent to the column 14, and various components contained in the liquid sample are temporally separated in the process of passing through the column 14 and elute from the outlet of the column 14. In this way, an eluate in which the types of components contained differ over time is introduced into the ESI probe 211 of the MS unit 2.

The measurement control unit 32 controls the power supply unit 4 and controls the various voltages applied to the MS unit 2, thereby causing the MS unit 2 to perform analysis on the sequentially supplied eluate. In the MS unit 2, it is possible to selectively perform normal mass spectrometry (MS analysis) without ion dissociation, and MS/MS analysis that dissociates ions by collision-induced dissociation (CID).

The ESI probe 211 sprays the supplied eluate as charged droplets into the ionization chamber 21. The charged droplets come into contact with the surrounding residual gas and are atomized, and in the process of the solvent in the droplets vaporizing, the compounds in the droplets become gas-phase ions. The generated ions are sent into the first intermediate vacuum chamber 22 via the desolvation tube 212, and are introduced into the quadrupole mass filter 241 sequentially through the ion guide 221, the skimmer 222, and the ion guide 231. In the case of MS analysis, the ions pass almost straight through the quadrupole mass filter 241 and the collision cell 242, and are transported to the orthogonal acceleration unit 251 via the ion guide 244.

On the other hand, in the case of MS/MS analysis, predetermined voltages are applied to each of the plurality of rod electrodes constituting the quadrupole mass filter 241, and ions having a specific m/z or an m/z included in a specific m/z range corresponding to those voltages selectively pass through the quadrupole mass filter 241 as precursor ions. A collision gas such as Ar gas is introduced into the collision cell 242, and the precursor ions come into contact with the collision gas and are dissociated by CID, generating various product ions. The generated product ions are transported to the orthogonal acceleration unit 251 via the ion guide 244.

A large number of ions that have reached the orthogonal acceleration unit 251 are accelerated substantially all at once in a direction substantially orthogonal to their incident direction. The accelerated ions fly in a folded path as indicated by the one-dot chain line C2 in FIG. 1 in the ion flight unit 252 at a speed corresponding to their respective m/z, and reach the ion detector 255. Various ions that departed from the orthogonal acceleration unit 251 at substantially the same time reach and are detected by the ion detector 255 in ascending order of m/z, and the ion detector 255 outputs detection data (ion intensity data) corresponding to the number of ions to the control/processing unit 3. In the control/processing unit 3, the data acquisition unit 33 saves the received data. The mass spectrum creation unit 34 creates a time-of-flight spectrum based on the collected data, and creates an MS spectrum or an MS/MS spectrum by converting the time of flight into m/z.

Note that the S/N ratio and sensitivity of the data obtained in one cycle of ion ejection from the orthogonal acceleration unit 251->ion flight in the ion flight unit 252->ion detection by the ion detector 255 are often not sufficiently high. Therefore, generally, the measurement cycle corresponding to the same m/z range is repeated continuously multiple times, and the data obtained in each of the multiple cycles are integrated to create a mass spectrum or an MS/MS spectrum.

### Description of Characteristic DDA Mode Operation

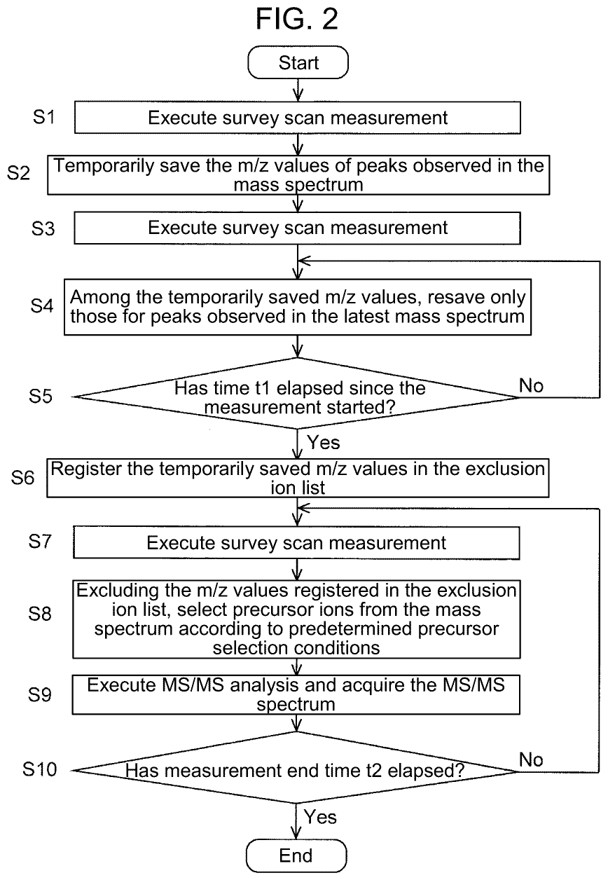

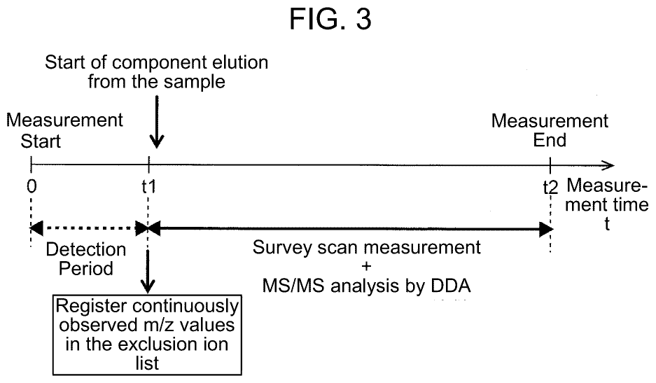

Next, the characteristic DDA mode operation performed in the MS unit 2 will be described. FIG. 2 is a flowchart of the operation execution procedure from the measurement start time to the end time, and FIG. 3 is a diagram schematically showing the relationship between measurement time and processing content in this operation.

Prior to the analysis, the user inputs measurement conditions for the DDA mode from the input unit 5, or changes default values that are predetermined as necessary. The measurement condition setting unit 31 accepts operations such as inputting or changing measurement conditions and saves the measurement conditions. These measurement conditions include precursor selection conditions and automatic exclusion ion detection conditions, which will be described later.

The precursor selection conditions are conditions for extracting one or more ion species as precursor ions in a mass spectrum, and can include, for example, the order of selection, such as in descending order of signal intensity, or in descending order within a predetermined range of signal intensity, and the number of peaks to be selected. Further, it can be configured such that conditions for ions to be preferentially selected or conditions for ions to be excluded during precursor selection can also be set. For example, for a compound that is important even if its signal intensity is low, the m/z value corresponding to that compound can be designated as a priority ion. Also, when it is desired to exclude the m/z value corresponding to a specific known compound from the selection target, the m/z value corresponding to such a compound can be designated as an exclusion ion. Note that for these precursor selection conditions, various conventionally known conditions can be used.

On the other hand, the automatic exclusion ion detection conditions are conditions for automatically extracting ions to be excluded from the precursor selection target based on the measurement results, and can specifically include a detection period for detecting the ions to be excluded (such as a detection start time and a detection end time), an exclusion validity period for continuing the exclusion after being registered in the exclusion ion list (such as an exclusion start time and an exclusion end time), and the like. It can also include conditions for the signal intensity and m/z range when detecting the peak of the ion to be excluded. In the following example, the detection period for exclusion ions is from the measurement start time (t=0) to the time when time t=t1 has elapsed. Also, the exclusion validity period is from the time of registration in the exclusion ion list to the measurement end time (t=t2).

When the measurement is started according to a user's instruction, the injector 13 in the LC unit 1 injects the liquid sample into the mobile phase. The injected liquid sample is introduced into the column 14, but it takes a certain amount of time for the various components contained in the liquid sample to start eluting from the outlet of the column 14. Therefore, for a while from the time of liquid sample injection, that is, the measurement start time, the eluate introduced into the ESI probe 211 substantially contains no sample components, but only the mobile phase.

The MS unit 2, under the control of the measurement control unit 32, repeatedly executes MS analysis over a predetermined m/z range, that is, a survey scan measurement, at predetermined time intervals. Although it is not actually a scan measurement because a TOFMS is used in the MS unit 2 here, it is called a survey scan measurement for convenience of explanation. Note that in this example, MS/MS analysis subsequent to the survey scan measurement is not executed until t=t1 is reached, but as will be described later, MS/MS analysis by DDA may be executed from the beginning of the measurement.

When the first survey scan measurement is executed, the data acquisition unit 33 receives signal intensity data in the survey scan measurement from the MS unit 2, and the mass spectrum creation unit 34 creates a mass spectrum over a predetermined m/z range (Step S1). When one mass spectrum is created, the exclusion ion identification unit 36 temporarily saves the m/z values of the peaks observed in that mass spectrum (Step S2). When a threshold for the signal intensity of a peak is set as the automatic exclusion ion detection condition described above, instead of all peaks on the mass spectrum, only peaks with a signal intensity equal to or greater than a predetermined threshold may be selected, and the m/z values of these peaks may be temporarily saved.

When the second survey scan measurement is executed in the MS unit 2 and a mass spectrum is created by the mass spectrum creation unit 34 (Step S3), the exclusion ion identification unit 36 re-saves only the m/z values of the peaks observed in the new mass spectrum from among the m/z values temporarily saved in Step S2, and deletes the other m/z values (Step S4). As a result, only the m/z values of peaks that were observed in both of the mass spectra obtained from two consecutive survey scan measurements are temporarily saved.

After that, the exclusion ion identification unit 36 determines whether the elapsed time from the measurement start time (t=0) has reached t1, which is set in the automatic exclusion ion detection conditions (Step S5), and if it has not elapsed, the process returns to Step S3. Therefore, the processing of Steps S3 to S5 is repeated during the period predetermined as the exclusion ion detection period. As a result, at the time when the elapsed time from the measurement start time reaches t1, that is, when Yes is determined in Step S5, the m/z values of ions that were continuously observed in the mass spectra during the exclusion ion detection period are saved in the exclusion ion identification unit 36.

As described above, since the components contained in the liquid sample injected from the injector 13 have not yet been introduced into the MS unit 2 immediately after the start of the measurement, it can be presumed that the components continuously observed during the exclusion ion detection period are components (contaminants) contained in the mobile phase that has been flowing from the beginning of the measurement. These components are clearly not the components that the user is targeting for observation. Therefore, when Yes is determined in Step S5, the exclusion ion identification unit 36 registers the m/z values temporarily saved at that time in the exclusion ion list prepared in the exclusion ion list storage unit 37 (Step S6). That is, the m/z values corresponding to components undesired by the user are automatically registered in the exclusion ion list.

Thereafter, when a survey scan measurement is executed in the MS unit 2 and the mass spectrum creation unit 34 creates a mass spectrum (Step S7), the precursor selection unit 35, among the peaks detected in the mass spectrum, excludes the m/z values registered in the exclusion ion list and extracts peaks that conform to the preset precursor selection conditions (Step S8). Therefore, even if ions corresponding to components that are undesired by the user and are contained in the mobile phase as described above are observed on the mass spectrum, those ions are not selected as precursor ions.

Now, assume that the precursor selection condition is to select one peak in descending order of signal intensity. In this case, in the above Step S8, among the peaks detected in the mass spectrum, the peak with the m/z value registered in the exclusion ion list is excluded, and among the other peaks, the ion corresponding to the one peak with the maximum signal intensity is selected as the precursor ion.

Subsequently, the measurement control unit 32 receives the information of the determined precursor ion and controls the MS unit 2 through the power supply unit 4 to execute an MS/MS analysis targeting that precursor ion. That is, if a peak that conforms to the precursor selection conditions is found in Step S8, an MS/MS analysis is performed subsequent to the survey scan measurement. The data acquisition unit 33 receives the detection data obtained by the MS/MS analysis from the MS unit 2, and the mass spectrum creation unit 34 creates an MS/MS spectrum (Step S9).

Next, the measurement control unit 32 determines whether the measurement end time t2, which was set as one of the measurement conditions in advance, has elapsed (Step S10), and if it has not elapsed, the process returns to Step S7. Therefore, as shown in FIG. 3, during the period from the time when the measurement time t has passed tl until the measurement end time t2 has passed, the processing of Steps S7 to S10 is repeated, and MS/MS analysis by DDA targeting the precursor ion selected under the precursor selection conditions excluding the m/z values registered in the exclusion ion list is repeated. Note that, although not shown in FIG. 2, if no peak conforming to the precursor selection conditions exists in Step S8, there is no precursor ion for which MS/MS analysis should be performed, so the process of Step S9 is skipped, the process proceeds to Step S10, and if the measurement end time t2 has not elapsed, the process returns to Step S7 and waits until the execution of the next survey scan measurement.

When some contaminants are mixed in the mobile phase as described above, the ions derived from those contaminants should be observed almost continuously from the start to the end of the measurement, although there may be fluctuations in signal intensity. In contrast, in the LC-MS of the above embodiment, the m/z values of such contaminant-derived ions can be automatically registered in the exclusion ion list, and the execution of MS/MS analysis with the contaminant-derived ions as precursor ions can be avoided until the end of the measurement. This can increase the probability of acquiring product ion information corresponding to components other than the contaminants, which the user originally wants to observe, and is effective for efficiently and comprehensively collecting product ion information.

### Modifications

In the above description, when confirming the presence or absence of a peak with the same m/z value as the m/z value temporarily saved in Step S4, it is preferable to determine that they are the same ion species if they fall within an m/z range determined by a predetermined tolerance width, rather than having completely the same m/z value. This makes it possible to detect the same ion species even when there is an error (resolution) or fluctuation in the m/z value during measurement.

Further, in the above description, MS/MS analysis subsequent to the survey scan measurement is not executed during the period from the execution of Step S1 until Yes is determined in Step S5, that is, the period until t1 elapses from the start of the measurement, but MS/MS analysis by DDA may be executed in the same way as in Step S7 and subsequent steps.

Further, in the example shown in FIG. 2, only one MS/MS analysis is performed subsequent to the survey scan measurement, but if time permits, multiple MS/MS analyses for mutually different precursor ions can be performed subsequent to the survey scan measurement.

Further, in the example shown in FIG. 2, the ion having the m/z value automatically registered in the exclusion ion list continues to be excluded from the precursor ion selection target until the measurement end time t2, but a function may be added to automatically delete the registered m/z value from the exclusion ion list when a predetermined release condition is met during the measurement.

Specifically, for example, even after one or more m/z values are registered in the exclusion ion list in Step S6, it may continue to be determined whether the peak of that m/z value is continuously observed in the mass spectrum obtained by the survey scan measurement, and if it is not continuously observed for a predetermined time, that m/z value may be deleted from the exclusion ion list.

For example, when performing gradient elution in the LC unit 1, the mixing ratio of two different mobile phases in the mobile phase supplied to the column 14 is changed over time. In that case, if some contaminant is mixed in one of the mobile phases, it may happen that the ion derived from that contaminant is observed for a while from the start of the measurement, and after a certain point in time, that ion is substantially no longer observed. In such a case, according to the above method, the m/z value of the ion derived from that contaminant can be deleted from the exclusion ion list during the measurement. Therefore, when an ion derived from another (or the same) component having the same m/z value as the ion derived from the contaminant is detected on the mass spectrum, MS/MS analysis can be performed with that ion as a precursor ion, contributing to the comprehensive collection of product ion information.

Further, in the above example, only the period from the measurement start time until tl has elapsed was set as the period for detecting continuously observed ions, but this period can be set to an arbitrary period according to the user's setting of the automatic exclusion ion detection conditions. Therefore, it is also possible to monitor the m/z values observed in the mass spectrum obtained by the survey scan measurement over the entire period during the measurement from the measurement start time to the measurement end, and if there is an m/z value that is continuously observed for a predetermined period at any point in time during the measurement, to register that m/z value in the exclusion ion list.

Furthermore, in order to regard m/z values as the same even if there is an m/z shift or m/z change due to constraints on the apparatus's performance such as m/z resolution, the m/z tolerance width for detection as described above may be used. However, in LC-MS and GC-MS, due to various factors such as changes in the state of the apparatus and changes in the external environment, a drift may occur in which the m/z value of the same ion species on the mass spectrum gradually shifts over time. When such a drift occurs, there is a concern that the apparent m/z value in the mass spectrum may exceed the tolerance width even if the true m/z value is the same. Therefore, when there is such a temporal drift of the m/z value, the following configuration can be adopted and processing using that configuration can be performed.

That is, a reference substance with a known m/z value is continuously added to the eluate coming out of the outlet of the column 14, and the peak of the reference substance is monitored on the mass spectrum obtained by the survey scan measurement, thereby grasping the m/z value shift with the passage of time from the measurement start time in real time. Then, according to the m/z value shift with the passage of time, the m/z value or m/z range that is determined to be the same ion species is also shifted. This makes it possible to accurately detect that the same ion species is continuously observed and register such an ion species in the exclusion ion list, even when there is a drift in the m/z value that does not fall within the normal fixed m/z tolerance width.

As described above, in the LC-MS of the above embodiment or its modifications, it is possible to avoid selecting ions derived from components that are undesired by the user, such as unknown contaminants mixed in the mobile phase, as precursor ions and performing MS/MS analysis. This makes it possible to efficiently and comprehensively collect product ion information corresponding to the originally targeted components.

Note that the precursor selection method described in the above embodiment can be combined with conventionally known or used techniques as long as it does not contradict them.

For example, a method is known in which an m/z value (and its tolerance value) to be excluded from precursor selection and an exclusion time range are set in advance, and the ion of the set m/z value is excluded over the set time range, but the above method can be used in combination with this. Also, for example, even if it is within the m/z or m/z range registered in the exclusion ion list as described above, an m/z value (and its tolerance value) that has been predetermined to be preferentially selected as a precursor ion may be selected as a precursor ion without being excluded.

Further, although the DDA mode operation was repeated in the description of the above embodiment, there are cases where another data acquisition method, Data Independent Acquisition (DIA), and DDA are performed alternately, or DDA is performed once for every multiple DIA acquisitions. Even in such cases, it is clear that the effects described above can be obtained by adopting the precursor selection method as described above in DDA.

Further, although the above embodiment applies the mass spectrometry apparatus according to the present invention to a Q-TOFMS, as described above, the present invention can be applied to all other types of mass spectrometry apparatuses capable of MS/MS analysis, such as triple quadrupole mass spectrometers, ion trap-time-of-flight mass spectrometers, and ion trap mass spectrometers. It is also clear that the ionization method in the ion source is not limited to ESI, and appropriate ionization methods such as APCI, PESI, DART, etc., can be used.

Furthermore, the above embodiment is merely an example of the present invention, and it is clear that appropriate modifications, changes, and additions made within the spirit of the present invention are included in the scope of the claims of the present application.

### Various Aspects

It is clear to those skilled in the art that the exemplary embodiments described above are specific examples of the following aspects.

(Clause 1) One aspect of the mass spectrometry method according to the present invention is a mass spectrometry method using a mass spectrometry apparatus capable of performing MS/MS analysis by data dependent acquisition, comprising: a detection step of detecting, based on mass spectra obtained by repeatedly executed survey scan measurements, a peak having an m/z value that is continuously observed over a predetermined period;
a registration step of registering the m/z value of the peak detected in the detection step or an m/z range including the m/z value in an exclusion ion list;
a precursor selection step of, after a mass spectrum is obtained by a survey scan measurement, excluding at least the m/z value or m/z range registered in the exclusion ion list from a precursor selection target in the mass spectrum, and extracting an ion that conforms to a predetermined precursor selection condition; and
a measurement step of executing an MS/MS analysis with the ion extracted in the precursor selection step as a precursor ion, subsequent to the survey scan measurement in the precursor selection step.

(Clause 6) One aspect of the mass spectrometry apparatus according to the present invention is a mass spectrometry apparatus capable of performing MS/MS analysis by data dependent acquisition, comprising:
a specific peak detection unit that detects, based on mass spectra obtained by repeatedly executed survey scan measurements, a peak having an m/z value that is continuously observed over a predetermined period;
an exclusion ion registration unit that registers the m/z value detected by the specific peak detection unit or an m/z range including the m/z value in an exclusion ion list;
a measurement unit that executes a survey scan measurement and, subsequent to the survey scan measurement, executes an MS/MS analysis with an ion extracted by a precursor selection unit described later, based on the mass spectrum obtained by the measurement, as a precursor ion; and
a precursor selection unit that, in the mass spectrum obtained by the survey scan measurement executed in the measurement unit, excludes at least the m/z value or m/z range registered in the exclusion ion list from a precursor selection target, and extracts an ion that conforms to a predetermined precursor selection condition.

According to the mass spectrometry method of Clause 1 and the mass spectrometry apparatus of Clause 6, it is possible to avoid the execution of MS/MS analysis where ions derived from components that may be observed throughout the entire measurement time, such as contaminants mixed in the mobile phase used in LC in an LC-MS, are selected as precursor ions. This makes it possible to more efficiently and comprehensively collect product ion information corresponding to the components originally targeted by the user contained in the sample.

(Clause 2) The mass spectrometry method according to Clause 1 may further comprise a deletion step of deleting the m/z value or m/z range registered in the exclusion ion list in the registration step from the exclusion ion list when a predetermined release condition is met.

(Clause 7) Further, in the mass spectrometry apparatus according to Clause 6, the exclusion ion registration unit may be configured to delete the m/z value or m/z range registered in the exclusion ion list from the exclusion ion list when a predetermined release condition is met.

According to the mass spectrometry method of Clause 2 and the mass spectrometry apparatus of Clause 7, when a sample containing another compound having the same m/z value as a contaminant with an m/z value once registered in the exclusion ion list is introduced, it is possible to increase the probability of being able to collect product ion information derived from the other compound in the sample.

(Clause 3) The mass spectrometry method according to Clause 1 or 2 may be a mass spectrometry method using a mass spectrometry apparatus to which a chromatograph is connected at a preceding stage, wherein the detection step detects a peak having an m/z value that is continuously observed over a predetermined period during the period until a component derived from a sample introduced into a column in the chromatograph exits the column and is introduced into the mass spectrometry apparatus.

(Clause 8) The mass spectrometry apparatus according to Clause 6 or 7 may be a mass spectrometry apparatus to which a chromatograph is connected at a preceding stage, wherein the specific peak detection unit detects a peak having an m/z value that is continuously observed over a predetermined period during the period until a component derived from a sample introduced into a column in the chromatograph exits the column and is introduced into the mass spectrometry apparatus.

According to the mass spectrometry method of Clause 3 and the mass spectrometry apparatus of Clause 8, even in cases where, for example, the mobile phase of the chromatograph contains contaminants unintended by the user, it is possible to avoid repeated MS/MS analysis on the contaminants and increase the probability of being able to collect product ion information derived from the originally targeted components.

(Clause 4) In the mass spectrometry method according to any one of Clauses 1 to 3, the detection step may regard peaks as having the same m/z value if they fall within a predetermined m/z tolerance width on the mass spectrum.

(Clause 9) In the mass spectrometry apparatus according to any one of Clauses 6 to 8, the specific peak detection unit may regard peaks as having the same m/z value if they fall within a predetermined m/z tolerance width on the mass spectrum.

According to the mass spectrometry method of Clause 4 and the mass spectrometry apparatus of Clause 9, even when errors, variations, or fluctuations occur in the apparent m/z value in the mass spectrum due to constraints of the apparatus's own performance (mass resolution) or variations in the measurement environment, measurement conditions, etc., it is possible to reliably capture the peak due to the same ion species and register it as an exclusion ion. This enables reliable detection of exclusion ions.

(Clause 5) The mass spectrometry method according to any one of Clauses 1 to 4 may further comprise a shift grasping step of grasping a shift of the m/z value over time, and in the detection step, the m/z value or m/z range that is regarded as a peak having the same m/z value on the mass spectrum may be changed according to the shift of the m/z value grasped in the shift grasping step.

(Clause 10) In the mass spectrometry apparatus according to any one of Clauses 6 to 9, the specific peak detection unit may be configured to change the m/z value or m/z range that is regarded as a peak having the same m/z value on the mass spectrum based on information of a shift of the m/z value over time.

According to the mass spectrometry method of Clause 5 and the mass spectrometry apparatus of Clause 10, for example, even in cases where the m/z value on the mass spectrum drifts despite the true m/z value being constant due to variations in the measurement environment, measurement conditions, etc., it is possible to reliably capture the peak due to the ion species showing such an m/z value and register it as an exclusion ion. This enables reliable detection of exclusion ions.

### REFERENCE SIGNS LIST

1 . . . Liquid chromatograph (LC) unit
11 . . . Mobile phase container
12 . . . Liquid delivery pump
13 . . . Injector
14 . . . Column
2 . . . Mass spectrometry (MS) unit
20 . . . Vacuum chamber
21 . . . Ionization chamber
211 . . . ESI probe
212 . . . Desolvation tube
22 . . . First intermediate vacuum chamber
221, 231, 243, 244 . . . Ion guide
222 . . . Skimmer
23 . . . Second intermediate vacuum chamber
24 . . . First high vacuum chamber
241 . . . Quadrupole mass filter
242 . . . Collision cell
25 . . . Second high vacuum chamber
251 . . . Orthogonal acceleration unit
252 . . . Ion flight unit
253 . . . Reflectron
255 . . . Ion detector
3 . . . Control/processing unit
31 . . . Measurement condition setting unit
32 . . . Measurement control unit
33 . . . Data acquisition unit
34 . . . Mass spectrum creation unit
35 . . . Precursor selection unit
36 . . . Exclusion ion identification unit
37 . . . Exclusion ion list storage unit
4 . . . Power supply unit
5 . . . Input unit
6 . . . Display unit

1. A mass spectrometry method using a mass spectrometry apparatus capable of performing MS/MS analysis by data dependent acquisition, the method comprising:
a detection step of detecting, based on mass spectra obtained by repeatedly executed survey scan measurements, a peak having an m/z value that is continuously observed over a predetermined period;
a registration step of registering the m/z value of the peak detected in the detection step or an m/z range including the m/z value in an exclusion ion list;
a precursor selection step of, after a mass spectrum is obtained by a survey scan measurement, excluding at least the m/z value or m/z range registered in the exclusion ion list from a precursor selection target in the mass spectrum, and extracting an ion that conforms to a predetermined precursor selection condition; and
a measurement step of executing an MS/MS analysis with the ion extracted in the precursor selection step as a precursor ion, subsequent to the survey scan measurement in the precursor selection step.

2. The mass spectrometry method according to claim 1, further comprising a deletion step of deleting the m/z value or m/z range registered in the exclusion ion list in the registration step from the exclusion ion list when a predetermined release condition is met.

3. The mass spectrometry method according to claim 1, wherein the mass spectrometry method uses a mass spectrometry apparatus to which a chromatograph is connected at a preceding stage, and
the detection step detects a peak having an m/z value that is continuously observed over a predetermined period during the period until a component derived from a sample introduced into a column in the chromatograph exits the column and is introduced into the mass spectrometry apparatus.

4. The mass spectrometry method according to claim 1, wherein the detection step regards peaks as having the same m/z value if they fall within a predetermined m/z tolerance width on the mass spectrum.

5. The mass spectrometry method according to claim 1, further comprising a shift grasping step of grasping a shift of the m/z value over time,
wherein the detection step changes the m/z value or m/z range that is regarded as a peak having the same m/z value on the mass spectrum according to the shift of the m/z value grasped in the shift grasping step.

6. A mass spectrometry apparatus capable of performing MS/MS analysis by data dependent acquisition, the apparatus comprising:
a specific peak detection unit that detects, based on mass spectra obtained by repeatedly executed survey scan measurements, a peak having an m/z value that is continuously observed over a predetermined period;
an exclusion ion registration unit that registers the m/z value of the peak detected by the specific peak detection unit or an m/z range including the m/z value in an exclusion ion list;
a measurement unit that executes a survey scan measurement and, subsequent to the survey scan measurement, executes an MS/MS analysis with an ion extracted by a precursor selection unit, based on the mass spectrum obtained by the measurement, as a precursor ion; and
a precursor selection unit that, in the mass spectrum obtained by the survey scan measurement executed in the measurement unit, excludes at least the m/z value or m/z range registered in the exclusion ion list from a precursor selection target, and extracts an ion that conforms to a predetermined precursor selection condition.

7. The mass spectrometry apparatus according to claim 6, wherein the exclusion ion registration unit deletes the m/z value or m/z range registered in the exclusion ion list from the exclusion ion list when a predetermined release condition is met.

8. The mass spectrometry apparatus according to claim 6, wherein the mass spectrometry apparatus is a mass spectrometry apparatus to which a chromatograph is connected at a preceding stage, and
the specific peak detection unit detects a peak having an m/z value that is continuously observed over a predetermined period during the period until a component derived from a sample introduced into a column in the chromatograph exits the column and is introduced into the mass spectrometry apparatus.

9. The mass spectrometry apparatus according to claim 6, wherein the specific peak detection unit regards peaks as having the same m/z value if they fall within a predetermined m/z tolerance width on the mass spectrum.

10. The mass spectrometry apparatus according to claim 6, wherein the specific peak detection unit changes the m/z value or m/z range that is regarded as a peak having the same m/z value on the mass spectrum based on information of a shift of the m/z value over time.
